(19) United States
(12) Patent Application Publication
(10) Pub. No.: US 2010/0030985 A1
(43) Pub. Date: Feb. 4, 2010

(54) Data backup apparatus

(75) Inventor: Jen-Chun Wang, Taipei County (TW)

Correspondence Address: BACON & THOMAS, PLLC, 625 SLATERS LANE, FOURTH FLOOR, ALEXANDRIA, VA, 22314-1176, US

(73) Assignee: PORTWELL INC., Taipei County (TW)

(21) Appl. No.: 12/382,374

(22) Filed: Mar. 16, 2009

(30) Foreign Application Priority Data
Jul. 30, 2008 (TW) 097213501

(51) Int. Cl. G06F 12/16; G06F 12/00; G06F 12/02

(52) U.S. Cl. 711/162; 711/115; 711/112

(57) ABSTRACT

In a data backup apparatus using memory as the data backup apparatus of an electronic device, the data backup apparatus includes a data backup module and a memory controller. The data backup module includes an interface card, and the interface card includes a plurality of memories which are carriers of backup data, and the memories are movably inserted into memory slots. The memory controller is provided for storing, reading and backing up data. With the memories, the data storage capacity can be expanded, and users can operate a start means to drive a memory controller to back up data directly into the data backup module. The invention can enhance the data backup speed and reduce human operating errors, so as to improve the security and efficiency of the data backup operation of the electronic device.

### BACKGROUND OF THE INVENTION

1. Field of the Invention

The present invention relates to a data backup apparatus of an electronic device, and more particularly to a data backup apparatus capable of effectively reducing human, environmental and operating errors to improve the security and efficiency of the storage backup operation of the electronic device.

2. Description of the Related Art

As an electronic device 100 such as a personal computer (PC) or an industrial PC (IPC) generally adopts a hard disk for data storage. With reference to FIG. 1 for the structure of a PC, the structure includes a main board 90, and the main board 90 includes a microprocessor 91 and a memory controller 92, and the memory controller 92 is connected to one or more hard disks 94 through an electric circuit 93, and the electric circuit 93 supports Integrated Device Electronic (IDE), Peripheral Component Interface (PCI) and Serial ATA (SATA). Since the most important task of a hard disk 94 is to store data and system files, it usually requires to have one or more backup of the data stored in the hard disk 94 based on the requirement of data security. Present existing hard disks 94 have to copy the desired data and system files one by one in the backup operation, and then write the data and system files back into the hard disk 95 (such as a detachable hard disk) one by one, and such backup operation mechanism is troublesome. Bad outcome will occur, if there is any missing data or system file. Furthermore, the hard disk may be damaged easily by any vibration occurred during the backup operation, and thus data lost is resulted. Therefore, existing hard disks have potential or unexpected risk for the storage backup operation, and flash memories are used for producing a Super Density or Secure Digital (SD) card, a Compact flash (CF) card, a Memory Stick (MS) card, a Multi Media Card (MMC) card or a Smart Card (SM) card and replacing the inconvenient hard disk. Therefore, various storage devices such as a USB storage device made of flash memories become a standard accessory. The flash memory storage devices of this sort have the advantages of easy installation, expansion, backup, plug-n-play, high security, low heat production, and good performance and vibration resisting function. However, the storage capacity of the flash memory storage devices is very limited, and thus these storages devices are not the mainstream of main storage devices or backup devices. At present, a general electronic device (such as a personal computer or an industrial computer) simply has a card reader of various different specifications installed on a panel of the electronic device, so that such flash memory storage devices are used simply as a portable storage medium. Therefore, it is an important subject of related manufacturers to develop a better storage backup mechanism for electronic devices and enhance the applications of the flash memory storage devices.

In view of the foregoing shortcomings of the prior art, the inventor of the present invention based on years of experience in the related industry to conduct extensive researches and experiments, and finally developed a data backup apparatus in accordance with the present invention to overcome the shortcomings of the prior art.

### SUMMARY OF THE INVENTION

It is a primary objective of the present invention to provide a data backup apparatus, and an electronic device has a memory slot for inserting a memory or expanding the data storage capacity, and a user operates a start means to drive a memory controller to execute a backup operation at the data backup module in the data storage module, so as to enhance the data backup speed, reduce human, environmental, and operating errors, and improve the security and efficiency of backup data operation of the electronic device.

To achieve the foregoing objective and effect, the present invention provides a data backup apparatus comprising a data backup module, a start means and a memory controller, wherein the data backup module includes an interface card, and the interface card includes a plurality of memories which are carriers of backup data for storing data or system files, and the memories are movably inserted into memory slots. The start means is provided for users to operate. With an input device such as a press key, a keyboard or a mouse installed at (or combined with) an appropriate position of the main system, keyboard or other device, a data backup instruction issued. The memory controller is provided for storing, reading and backing up data.

The technical measure of the invention further comprises a main board, and the main board includes at least one interface card slot for inserting an interface card of the data backup module.

To make it easier for our examiner to understand the objective of the invention, its technical characteristics, and performance, we use preferred embodiments together with the attached drawings for the detailed description of the invention as follows.

### BRIEF DESCRIPTION OF THE DRAWINGS

FIG. 1 is a schematic view of a conventional hard disk storage backup device;

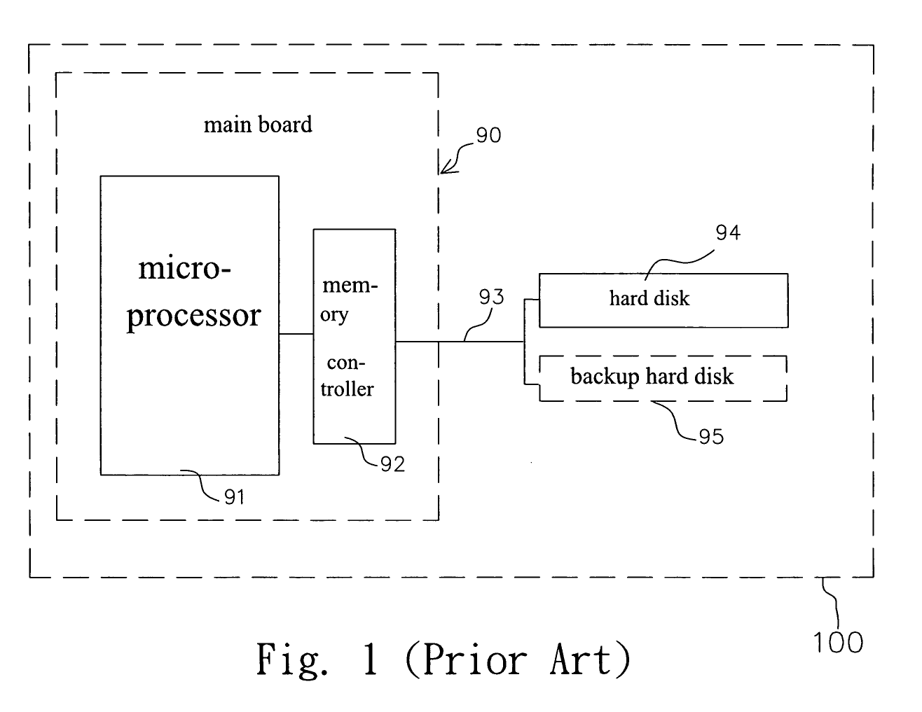

FIG. 2 is a schematic view of a data backup apparatus in accordance with a first preferred embodiment of the present invention;

FIG. 3 is an exploded view of a data backup module in accordance with a first preferred embodiment of the present invention;

FIG. 4 is a schematic view of a data backup apparatus in accordance with a second preferred embodiment of the present invention;

FIG. 5 is a schematic view of a data backup apparatus in accordance with a third preferred embodiment of the present invention; and

FIG. 6 is a schematic view of an application of FIG. 5.

### DETAILED DESCRIPTION OF THE PREFERRED EMBODIMENTS

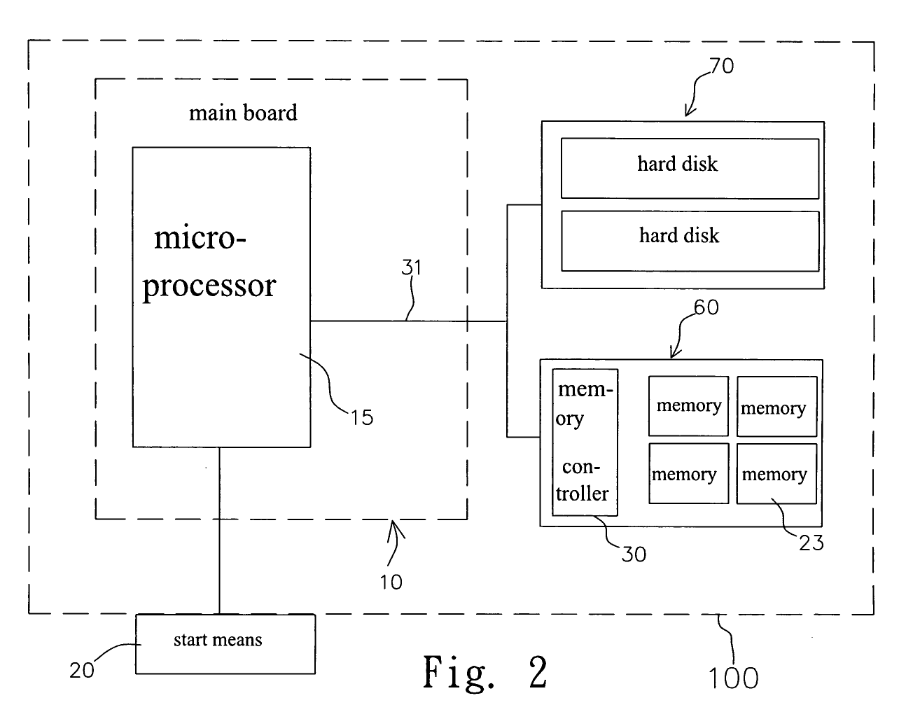

With reference to FIG. 2 for a data backup apparatus in accordance with a first preferred embodiment of the present invention, a memory is used as the data backup apparatus of an electronic device 100, and the data backup apparatus comprises a main board 10, a start means 20, a memory controller 30, a data backup module 60 and a data storage module 70; wherein the main board 10 includes a microprocessor (MCU) 15 installed thereon, and the microprocessor controls the operation of the electronic device 100. The control operation is a prior art and not the key point of the present invention, and thus will not be described here. The start means 20 is electrically coupled to the microprocessor 15 and provided for users to operate, and a user presses an input device such as a press key, a keyboard, or a mouse (not shown in the figure) to drive the microprocessor 15 to issue a data backup instruction, and the press key can be installed at (or combined with) an appropriate position of the main system, keyboard or other equipment; wherein the memory controller 30 is installed on the data backup module 60. The electric circuit 31 and the microprocessor 15 are electrically coupled, and the memory controller 30 receives an instruction from the microprocessor 15 to execute a data backup operation. Further, the memory controller 30 supports Peripheral Component Interface (PCI), Serial ATA (SATA), External Serial ATA (ESATA), Personal Computer Memory Card International Association (PCMCIA) transmission protocol.

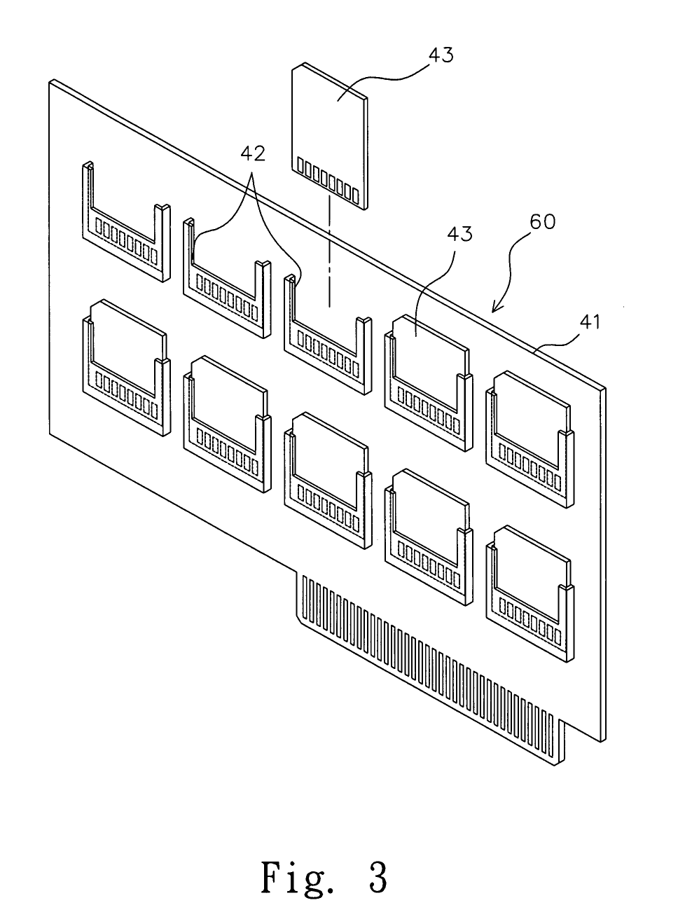

With reference to FIG. 3, the data backup module 60 further includes at least one interface card 41, and the interface card 41 includes a plurality of memory slots 42 for inserting a memory 43, and the memory 43 is a carrier for copying data and system files, and the memory slot 42 and memory 43 comply with various different specifications of Super Density or Secure Digital (SD) card, a Compact flash (CF) card, a Memory Stick (MS) card, a Multi Media Card (MMC) card or a Smart Card (SM) card. In the data storage module 70, a hard disk is used as a carrier for storing data and system files in the electronic device (as shown in FIG. 2).

With reference to FIG. 2, a user operates the start means 20 to drive the microprocessor 15 to issue an instruction and the memory controller 30 to execute a data backup operation, and directly back up the data of the data storage module 70 into a memory 43 of the data backup module 60 directly through an electric circuit 31.

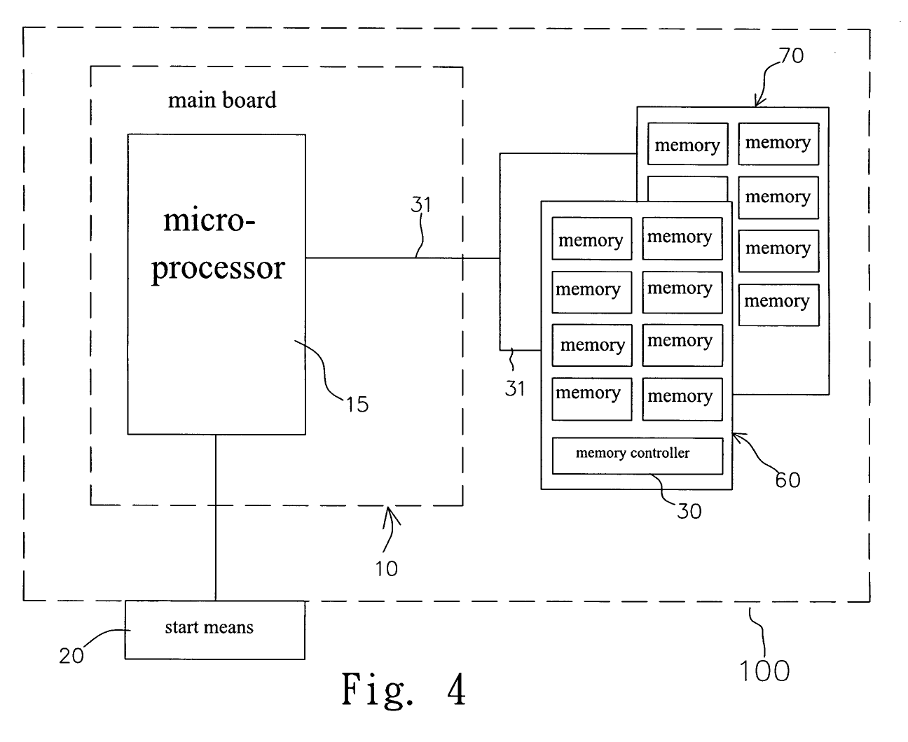

With reference to FIG. 4 for a data backup apparatus in accordance with a second preferred embodiment of the present invention, the difference of this embodiment with the first preferred embodiment resides on that the data storage module 70 uses a memory as a carrier for storing data and system files in the electronic device.

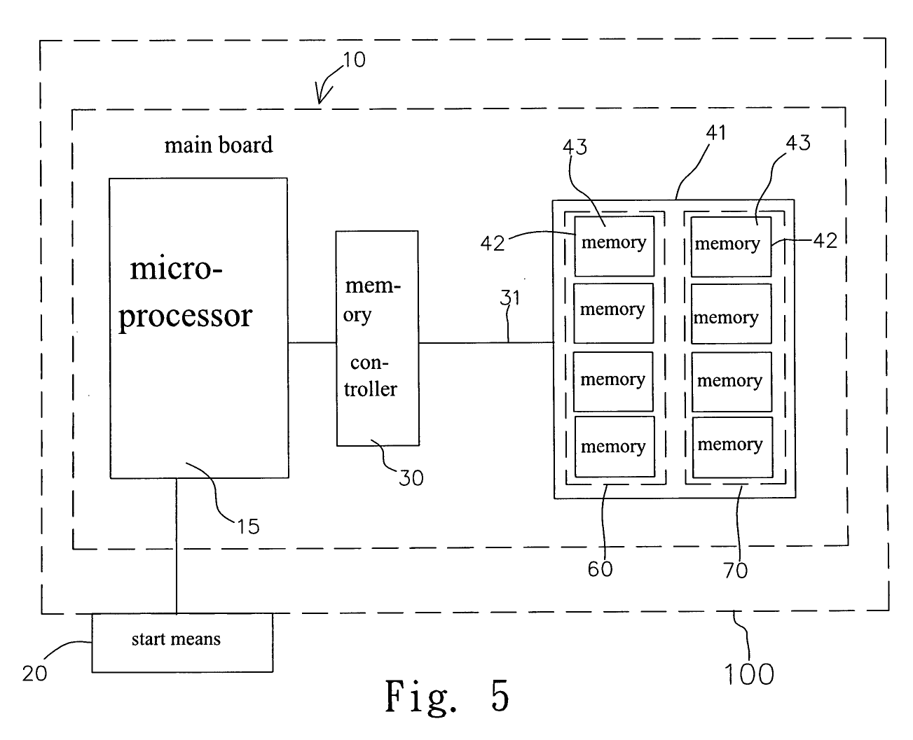

With reference to FIG. 5 for a data backup apparatus in accordance with a third preferred embodiment of the present invention, the difference of this embodiment from the foregoing preferred embodiments resides on that the memory controller 30 is installed on the main board 10, and the microprocessor 15 is electrically coupled to the start means 20, the data backup module 60 and the data storage module 70. The user operates the start means 20 to drive the microprocessor 15 to drive the memory controller 30 to execute a data backup operation directly and backup the data stored in the data storage module 70 to a memory 43 of the data backup module 60 through the electric circuit 31.

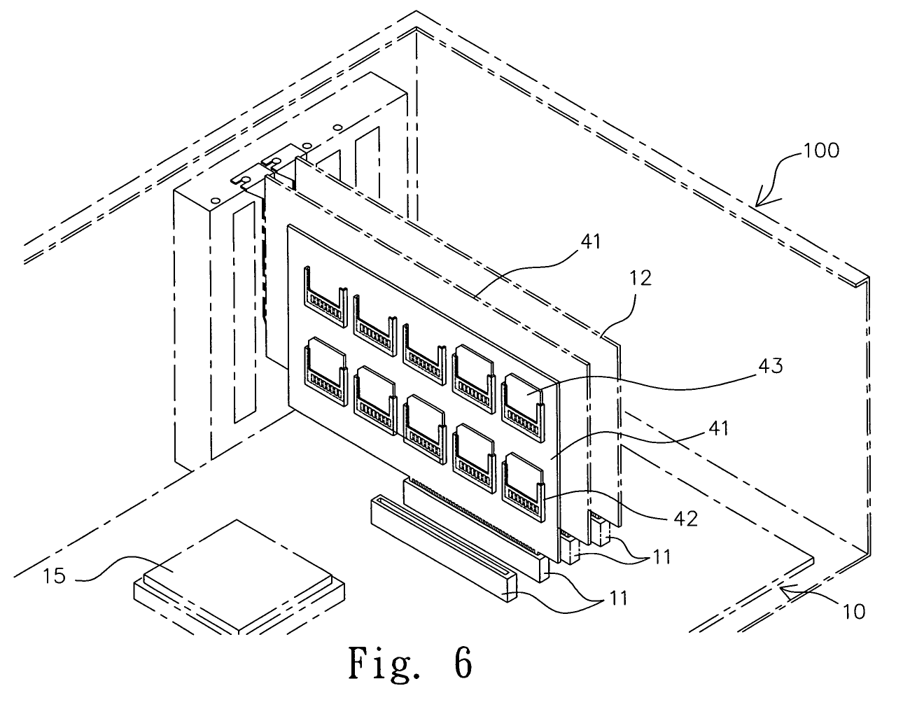

With reference to FIG. 6 for a data backup apparatus in accordance with a fourth preferred embodiment of the present invention, the difference of this embodiment from the foregoing preferred embodiments resides on that the data backup module 60 is installed on the main board 10, and the electric circuit 31 and the memory controller 30 are electrically coupled with each other, and the main board 10 is installed in an electronic device 100, and the main board 10 includes interface card slots 11, 12, and the interface card slot 11 is used for inserting the interface card 41, and forming the data storage module 70 and the data backup module 60, and the interface card slots 11, 12 are connected to the memory controller 30 and the microprocessor 15 by the electric circuit 31.

In the electronic device of the present invention, when a memory is used for storing and backing up data, the memory is inserted into a memory slot of the interface card. Since the interface card has a plurality of memory slots of the data storage module and the data backup module, or a plurality of memory slots on interface cards of the data storage module and data backup module, therefore the number of memories inserted into the memory slot can vary as needed, and the memory capacity can be expanded when needed. The available memory slot is used for adding memories. Users can start the start means (such as operating a press key) flexibly and easily to complete an automatic storage backup operation. If the memory capacity of the data backup module of one interface card is insufficient, users can use an additional data backup module of the interface card for expanding the storage capacity to meet the requirement of expanding the storage capacity.

Since the present invention uses a built-in memory slot for installing memories, and a circuit for forming a data storage module and a data backup module, therefore the backup operation with such storage capacity can be achieved by pressing the press key to start an automatic backup easily. Users can back up data flexibly as needed. The invention improves the backup speed and reduces human and operating errors, so as to enhance the security and efficiency of the storage backup operation of the electronic device, and even work with a ReadyBoost (which is a booster of Windows Vista) to increase the system response speed of an electronic device (such as a computer), so that users can access data in the memory much faster than the hard disk, and thus the performance of the system operation, storage and backup can be improved.

While the invention has been described by means of specific embodiments, numerous modifications and variations could be made thereto by those skilled in the art without departing from the scope and spirit of the invention set forth in the claims.

What is claimed is:

1. A data backup apparatus, particularly one using a memory as said data backup apparatus in an electronic device, and said data backup apparatus comprising:
a main board;
a microprocessor (MCU), installed on said main board, for controlling an operation of said electronic device;
a data storage module, electrically coupled to said microprocessor, for storing a data or a system file of said electronic device;
a data backup module, electrically coupled to said microprocessor, and its storage carrier being a memory, and said data backup module including an interface card, and said interface card having at least one memory slot for inserting said memory, and said memory being provided for copying and backing up said data and said system file in said data storage module;
a memory controller, installed on said data backup module, and electrically coupled to said data backup module, for storing and reading data;
a start means, electrically coupled to said microprocessor, and operated by a user, for executing a data backup operation by said memory controller driven by said microprocessor.

2. The data backup apparatus according to claim 1, wherein said storage carrier of said data storage module is a hard disk.

3. The data backup apparatus according to claim 1, wherein said storage carrier of said data storage module is a memory, and said data storage module includes an interface card, and said interface card includes at least one memory slot for inserting said memory, and said memory is provided for storing a data or a system file of said electronic device.

4. The data backup apparatus according to claim 1, wherein said memory complies with a flash memory specification including a SD card, a CF card, a MS card, a MMC card, a SM card, a SATA card, an ESATA card, a PCI card, a PCI-E card or a PCMCIA card.

5. The data backup apparatus according to claim 1, wherein said memory controller supports PCI, SATA, ESATA and PCMCIA transmission protocols.

6. The data backup apparatus according to claim 1, wherein said start means is a press key, a keyboard or a mouse provided for said microprocessor to issue a data backup instruction.

7. The data backup apparatus according to claim 6, wherein said start means is installed on a casing or an input device of said electronic device.

8. The data backup apparatus according to claim 3, wherein said data backup module and said data backup module are situated on a same interface card.

9. A data backup apparatus, comprising:
a main board, having an interface card slot thereon;
a microprocessor (MCU), installed on said main board, for controlling an operation of said electronic device;
a data storage module, electrically coupled to said microprocessor, for storing a data or a system file of said electronic device;
a data backup module, electrically coupled to said microprocessor, and its storage carrier being a memory, and said data backup module including an interface card, and said interface card having at least one memory slot for inserting said memory, and said memory being provided for copying and backing up said data and said system file in said data storage module;
a memory controller, installed on said main board, and electrically coupled to said data backup module, for storing and reading data; and
a start means, electrically coupled to said microprocessor, and operated by a user, for executing a data backup operation by said memory controller driven by said microprocessor.

10. The data backup apparatus according to claim 9, wherein said storage carrier of said data storage module is a hard disk.

11. The data backup apparatus according to claim 9, wherein said storage carrier of said data storage module is a memory, and said data storage module includes an interface card, and said interface card includes at least one memory slot for inserting said memory, and said memory is provided for storing a data or a system file of said electronic device.

12. The data backup apparatus according to claim 9, wherein said memory complies with a flash memory specification including a SD card, a CF card, a MS card, a MMC card, a SM card, a SATA card, an ESATA card, a PCI card, a PCI-E card or a PCMCIA card.

13. The data backup apparatus according to claim 10, wherein said memory complies with a flash memory specification including a SD card, a CF card, a MS card, a MMC card, a SM card, a SATA card, an ESATA card, a PCI card, a PCI-E card or a PCMCIA card.

14. The data backup apparatus according to claim 9, wherein said memory controller supports PCI, SATA, ESATA and PCMCIA transmission protocols.

15. The data backup apparatus according to claim 9, wherein said start means is a press key, a keyboard or a mouse provided for said microprocessor to issue a data backup instruction.

16. The data backup apparatus according to claim 15, wherein said start means is installed on a casing or an input device of said electronic device.

17. The data backup apparatus according to claim 9, wherein said main board includes a plurality of interface card slots disposed thereon.

18. The data backup apparatus according to claim 17, wherein said data backup module and said data backup module are situated at a same interface card.

19. The data backup apparatus according to claim 17, wherein said data backup module and said data backup module are situated at different interface cards.
